(19) United States
(12) Patent Application Publication
(10) Pub. No.: US 2007/0006656 A1
(43) Pub. Date: Jan. 11, 2007

(54) System and method for monitoring deposition within tubes of a heating system

(75) Inventors: Thomas James Batzinger, Burnt Hills, NY (US); Bruno Hans Haider, Ballston Lake, NY (US); Peter S. Allison, Conroe, TX (US); Mel J. Esmacher, Spring, TX (US)

Correspondence Address: GENERAL ELECTRIC COMPANY;GLOBAL RESEARCH, PATENT DOCKET RM. BLDG. K1-4A59, NISKAYUNA, NY, 12309, US

(73) Assignee: General Electric Company

(21) Appl. No.: 11/177,655

(22) Filed: Jul. 11, 2005

(51) Int. Cl. G01N 29/04

(52) U.S. Cl. 73/606

(57) ABSTRACT

A system and method for determining deposition parameters within an industrial heating system is provided. The system includes a phased array probe arranged adjacent to a tube within the industrial heating system. The phased array probe transmits and receives signals. A processing unit is in communication with the phased array probe for processing the received signals to generate data on deposition parameters of the tube. A display unit is coupled to the processing unit for displaying the data.

### BACKGROUND

The present invention relates generally to non-destructive testing techniques, and more particularly, to a system and method for monitoring the condition of tubes and pipes used in industrial applications.

In the operation of industrial systems such as boilers, heat exchangers and other process flow tubes or pipes, material deposition on the inside of the tubes or pipes can block heat transfer or cause flow restrictions. In the case of boilers, this heat transfer blockage or flow restriction can lead to the development of “hot spots” or areas not cooled by the water flowing inside the tubes.

These hot spots can cause a degradation of the tube, possibly leading to rupture of the tube. Rupture of boiler tubes and process piping may critically injure personnel in the vicinity. In addition, rupture or blockage of tubes can cause expensive repair costs and related loss of production, as forced outages are required to correct deposit-related failures. Furthermore, deposition or fouling of heat exchangers reduces the efficiency of the heat exchanger, leading to increased process costs. This is because heat flux from the hot fluid to the cooler fluid may be hindered due to the deposition within the tubes.

One conventional method of measuring deposit accumulation within tubes and pipes is by determining the presence and measuring the dimensions of deposits within these vessels via borescopes. This method may require flow of fluid within the tube to be stopped, the tube drained of fluid, and the borescope inserted into the tube through an access port and guided to the area of interest. Similarly, another traditional method of estimating the deposit buildup in boiler tubing requires representative tube sections to be physically cut from the boiler, followed by laboratory tests for the deposit thickness. These methods cause forced outages.

There is therefore, a need for a system and method for monitoring and tracking the condition of tubes within a heating system without long durations of suspended operation.

### SUMMARY

According to one aspect of the present technique, a system and method for determining deposition parameters within an industrial heating system is provided. The system includes a phased array probe arranged adjacent to a tube within the industrial heating system. The phased array probe transmits and receives signals. A processing unit is in communication with the phased array probe for processing the received signals to generate data on deposition parameters of the tube. A display unit is coupled to the processing unit for displaying the data.

In accordance with another aspect of the present technique, a system and method for determining parameters of a tube within a heating system is provided. The method includes receiving signals by a probe placed adjacent to a tube, processing the received signals for generating data on parameters of the tube, and displaying the data on a display unit.

In accordance with still another aspect of the present technique, a system and method for providing maintenance of tubes within a heating system is provided. The method includes receiving acoustic signals by an ultrasound probe placed adjacent to each of the tubes, processing the received acoustic signals for generating an internal image of each of the tubes, and alerting personnel based on the internal image of each of the tubes.

These and other advantages and features will be more readily understood from the following detailed description of preferred embodiments of the invention that is provided in connection with the accompanying drawings.

### BRIEF DESCRIPTION OF THE DRAWINGS

FIG. 1 is a cross-sectional view of a boiler illustrating a heating system constructed in accordance with an exemplary embodiment of the invention.

FIG. 2 is an expanded view of circle II of FIG. 1.

FIG. 3 is a cross-sectional view of a tube within the boiler of FIG. 1 illustrating direct reflection measurement of deposit using pulsed array ultrasound technique in accordance with an exemplary embodiment of the invention.

FIG. 4 is a cross-sectional view of a tube within the boiler of FIG. 1 illustrating pulsed Doppler flow measurement in accordance with an exemplary embodiment of the invention.

### DETAILED DESCRIPTION OF EXEMPLARY EMBODIMENTS

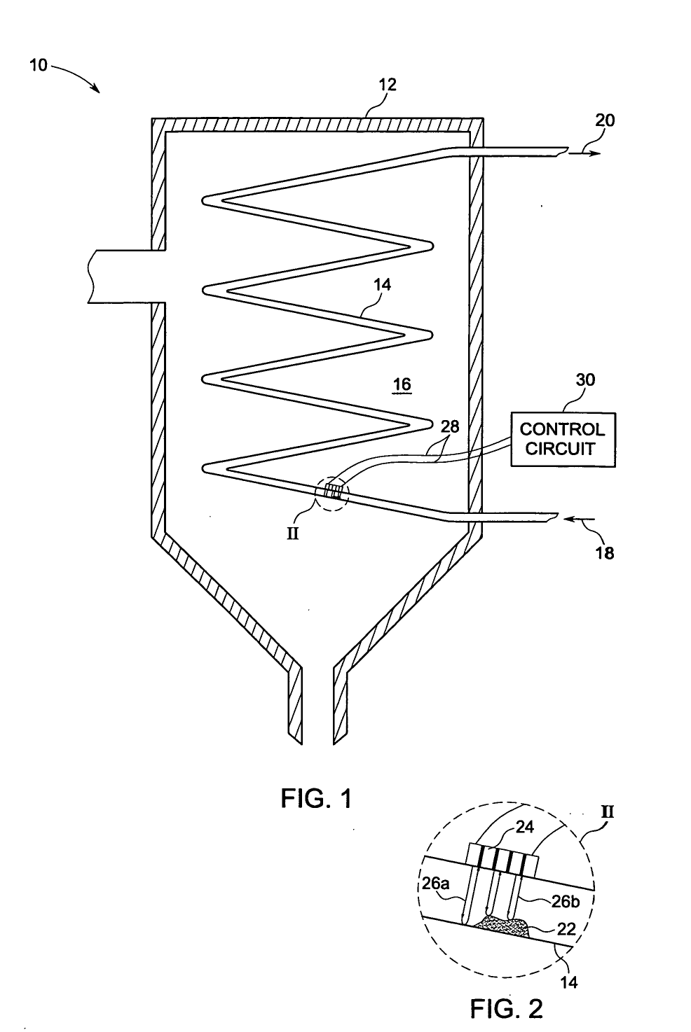

FIG. 1 illustrates a boiler 12 in a heating system. A deposition monitoring system 10 is used in conjunction with the boiler 12 for monitoring the thickness of deposition within tubes 14 of the boiler 12. It should be appreciated, however, that the deposition monitoring system 10 may find application in a range of settings and systems, and that its use in the heating system shown is but one such application. For example, the deposition monitoring system 10 may be used in pipes and tubes in heat exchangers, boilers, water transmission systems, and the like for monitoring parameters such as thickness of deposits, location of deposits, changes in fluid flow patterns, etc. within the pipes and tubes. Furthermore, the monitoring system 10 may be used in conjunction with a centralized monitoring system capable of tracking and recording events for future use or alerting personnel for maintenance, such as via an electronic mail service or an electronic text message system, based on the condition of the tubes or pipes.

In one exemplary embodiment, boiler 12 includes tubes 14 that allow passage of fluid within a boiler chamber 16 either for regulating the temperature within the boiler chamber 16, or for preheating the material within boiler 12. For maintaining uniform temperature within the boiler chamber 16, a fluid such as water may be passed into the boiler 12 via tubes 14 as shown by arrow 18. The fluid passed into the tubes 14 thus allows uniform application of heat to the material within boiler 12.

Similarly, preheating the material within boiler 12 may be performed by passing steam into the boiler tubes 14 in a direction reverse to that shown by arrow 20. The steam may condense into water and can flow out through the tube 14 in the direction opposite to that shown by arrow 18.

Over a period of usage, there may be formation of thin layers of deposits within the insides of the tubes 14, as illustrated in circle II. This is due to dissolved material in the fluid passing through the tubes 14. Referring now to FIG. 2, which is an expanded view of circle II of FIG. 1, material deposit 22 within tube 14 is illustrated. The thickness and location of deposit 22, or the flow pattern of the fluid within the tube 14, may be gauged by a probe 24. The probe 24 may be placed adjacent to the tube 14. By “adjacent” is meant that the probe 24 may be placed in contact with or proximate to the tube 14. The probe 24 may be an ultrasound probe that performs direct reflection measurement of deposit 22. However, in various other embodiments, probe 24 may include an ultrasound probe that operates via pulsed Doppler flow measurement techniques.

The probe 24 may transmit a signal, such as an acoustic signal 26a into the tube 14, which undergoes reflection from the opposite surface of the tube 14. The reflected signal 26b is received by the probe 24 and may be converted into an electrical signal prior to processing. Referring back to FIG. 1, leads 28 may serve to power the probe 24, and to transmit the signals to and from the probe 24. Control circuitry 30 may be utilized to control the operation of the probe 24. The control circuitry 30 may also perform any required preprocessing of the received signals, such as calculating the thickness of the deposit, flow pattern of the fluid, etc. The control circuitry 30 may further transmit signals to a centralized processing unit, which is capable of issuing alerts to a maintenance personnel, displaying the results on a display unit, and the like. In other embodiments, heat exchanger tubes, water transmission tubes, and the like may be monitored.

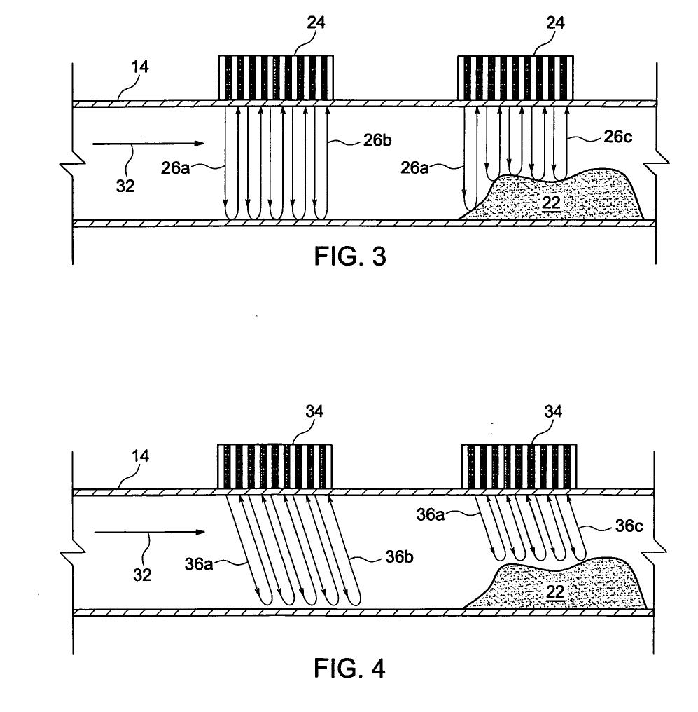

Referring now to FIG. 3, a cross-sectional view through a tube 14 within the boiler of FIG. 1 is illustrated. Over a period of usage, the flow of fluid, indicated by the arrow 32, may cause deposition of scales 22 within the tube 14. These deposits may occur due to calcium carbonate or other dissolved impurities present in the fluid. Direct reflection measurement of deposit 22, using a pulsed array ultrasound technique, may be performed via an ultrasound probe 24 to determine the presence and/or dimensions of these deposits 22. The ultrasound probe 24 transmits an acoustic signal 26a into the tube 14, which reflects back as a reflected signal 26b from the opposite walls of the tube 14. If the acoustic signals encounter a deposit 22, a portion 26c of the acoustic signals will reflect back from the surface of the deposit 22, as illustrated. This is because of the acoustic impedance differences between the fluid and the deposit 22. An acoustic impedance mismatch of sufficient amount, such as an acoustic impedance mismatch ratio of 2:1, may be required so that acoustic reflection occurs. Similarly, lower acoustic impedance mismatch ratios also allow acoustic reflection. In one embodiment, the control circuitry 30 may generate an image of the deposit 22 by utilizing a lateral beam scanning technique.

In a different embodiment, a phased array ultrasound probe 24 may be utilized for generating an image of the deposit 22 or for determining the thickness of deposit 22. A phased array ultrasound probe 24 includes an array of ultrasound transducers whose signals are combined after appropriate time delays. The resulting signal generated may be detected with a suitable detector, such as a square law detector. Phased array ultrasonic technique controls generation of an ultrasonic beam with desired characteristics (such as beam focus and beam direction), and electronically controls beam scanning over the length of the probe 24.

According to another embodiment, the time it takes for the acoustic signals 26b to reflect from the walls of the tube 14 or the acoustic signals 26c to reflect from the deposits 22 may be utilized for determining the dimensions of the deposit. Because deposit 22 will render the tube's inner dimensions narrower at locations where deposit 22 exists, such a technique may be implemented. Based on the amount of time it takes for the acoustic echoes 26b, 26c to return to the ultrasound probe 24, the control circuitry 30 may compute the dimensions of the deposit 22. Furthermore, the control circuitry 30 may generate a cross-sectional image of the entire tube 14 including the deposit 22, based on the same principle.

The aforementioned techniques may therefore determine the dimensions of the deposit 22. For example, the size or the thickness of the deposit 22 may be determined. Because the deposit 22 may restrict the diameter of the tube 14, fluid flow velocity within the tube 14 increases. Therefore, flow patterns of the fluid, such as a change in fluid flow velocity, may be computed by the control circuitry 30, based on the dimensions of the deposit 22.

Turning now to FIG. 4, a tube 14 within the boiler of FIG. 1 is illustrated. When sufficient acoustic impedance mismatch does not exist between the fluid and the deposit 22, a pulsed Doppler flow measurement technique may be implemented. A phased array ultrasound probe 34 may be utilized for this technique. Probe 34 transmits acoustic signals 36a into the tube 14. Due to the speed and direction of fluid flow within the tube 14, the reflected acoustic signals 36b will undergo a frequency change. This results in a Doppler shift. Analyzing the Doppler shift data provides a means to image the cross-sectional profile of the fluid flow. With no restriction in fluid flow (i.e., with no deposit layer 22), the reflected acoustic signals 36b will not produce a restriction profile, when analyzed by the control circuitry 30. However, when there exists a restriction in fluid flow (i.e., with accumulation in deposit layer 22), the reflected acoustic signals 36c will produce a restriction profile. This is because the Doppler shift is only generated from moving fluid particles and not from stationary deposits.

The control circuitry 30 can therefore differentiate the change in fluid flow velocity with and without a deposit layer 22, in the illustrated embodiment. Thus, control circuitry 30 can visualize any blockage in the fluid flow within the tubes 14. An image of the flow pattern within the tubes 14 may be produced by the control circuitry 30 using the characteristics of phased array ultrasound technology previously discussed with respect to FIG. 3. In this case, the image of flow produced by the control circuitry 30 will display the restriction of flow caused by deposits 22 within the tube 14. In another embodiment, the amount of restriction allows determination of the amount of cross-section available for fluid flow. This technique also provides data for determining fluid flow pattern within the end cap portions of a heat exchanger. Determination of fluid flow patterns into the cooling tubes contained within a heat exchanger allows areas of the heat exchanger where flow is restricted by either deposits or fouling in the tube to be determined. This will also enable determination of the reduction of heat exchanger efficiency.

Another method related to the Doppler shift technique is a B-Flow imaging technique. The B-Flow imaging technique highlights the locations where fluid flow exists. The B-Flow imaging technique relies on immobility of the echo signals, which is an echo subtraction filtering technique. The tube 14 and the deposit 22 are stationary, while the fluid flow is dynamic. Several image frames or image lines may be captured as described previously with respect to FIGS. 3 and 4. Subtracting subsequent image frames (or image lines) from each other cancels out the stationary targets (tube 14 and deposit 22), while enhancing the non-stationary fluid flow. Using the images produced and the software available in the control circuitry 30, direct determination of deposit dimensions as well as the change in fluid flow patterns within tubes or pipes 14 used in various industrial applications, may be performed.

Moreover, alternate processing techniques, such as spectral Doppler analysis or signal correlation may be applied to detect and quantify flow states. For example, spectral processing is achieved by acquiring the Fourier Transform of signals (e.g., range-gated echo samples) from beams that interrogate the same spatial direction. Similarly, correlation processing (e.g., time-domain correlation processing) correlates echo segments of one beam to the echo segment for the substantially same spatial direction, but at a later point in time.

While the invention has been described in detail in connection with only a limited number of embodiments, it should be readily understood that the invention is not limited to such disclosed embodiments. Rather, the invention can be modified to incorporate any number of variations, alterations, substitutions or equivalent arrangements not heretofore described, but which are commensurate with the spirit and scope of the invention. Additionally, while various embodiments of the invention have been described, it is to be understood that aspects of the invention may include only some of the described embodiments. Accordingly, the invention is not to be seen as limited by the foregoing description, but is only limited by the scope of the appended claims.

What is claimed as new and desired to be protected by Letters Patent of the United States is:

1. A system for determining deposition parameters within an industrial: heating system, comprising:
a phased array probe arranged adjacent to a tube within the industrial heating system and configured to transmit and receive signals;
a processing unit in communication with the phased array probe and configured to process received signals to generate data on deposition parameters of the tube; and
a display unit coupled to the processing unit and configured to display the data.

2. The system as recited in claim 1, wherein the heating system comprises a heat exchanger.

3. The system as recited in claim 1, wherein the heating system comprises a boiler.

4. The system as recited in claim 1, wherein at least one of the deposition parameters comprises thickness of deposits within the tube, location of deposits within the tube, or changes in fluid flow patterns in the tube.

5. The system as recited in claim 1, wherein the phased array probe comprises an ultrasound probe.

6. The system as recited in claim 1, wherein the phased array probe is configured to generate an acoustic signal.

7. The system as recited in claim 1, wherein the data comprises an internal image of the tube, and wherein the internal image of the tube is representative of the deposition parameters of the tube.

8. The system as recited in claim 1, wherein the processing unit issues an alert based on the deposition parameters of the tube.

9. The system as recited in claim 1, wherein the processing unit is configured to process received signals to generate an image within the tube.

10. The system as recited in claim 9, wherein the processing unit is configured to process received signals to generate an image of the flow patterns within the tube.

11. The system as recited in claim 10, wherein the image of the flow patterns within the tube is representative of at least one of thickness of deposits within the tube, location of deposits within the tube, or changes in fluid flow patterns in the tube.

12. The system as recited in claim 9, wherein the probe is configured to transmit and receive signals for providing echo subtraction filtering and wherein the image provides data on deposition parameters of the tube.

13. The system as recited in claim 10, wherein the probe is configured to transmit and receive signals either for providing spectral processing or for providing correlation processing.

14. The system as recited in claim 1, wherein the heating system comprises a water transmission system.

15. A method for determining parameters of a tube within a heating system, comprising:
receiving signals by a probe placed adjacent to a tube;
processing the received signals for generating data on parameters of the tube; and
displaying the data on a display unit.

16. The method as recited in claim 15, wherein said receiving signals comprises transmitting signals into the tube and receiving reflected signals.

17. The method as recited in claim 15, wherein said transmitting signals comprises transmitting acoustic signals.

18. The method as recited in claim 16, wherein said generating data comprises generating an internal image of the tube.

19. The method as recited in claim 15, wherein said generating data comprises generating data on at least one of thickness of deposit within the tube, location of deposit within the tube, or changes in fluid flow patterns within the tube.

20. The method as recited in claim 15, wherein said generating data comprises generating an image of flow patterns within the tube.

21. The method as recited in claim 15, wherein said receiving signals comprises receiving signals by a probe placed adjacent to the tube for providing echo subtraction filtering.

22. A method for providing maintenance of tubes within a heating system, comprising:
receiving acoustic signals by an ultrasound probe placed adjacent to each of the tubes;
processing the received acoustic signals for generating an internal image of each of the tubes; and
alerting personnel based on the internal image of each of the tubes.

23. The method as recited in claim 22, wherein said alerting comprises alerting the personnel via an electronic mail service or an electronic text message system.
